(19) United States
(12) Patent Application Publication
(10) Pub. No.: US 2019/0111490 A1
(43) Pub. Date: Apr. 18, 2019

(54) SYSTEM FOR SPRAYING PARTICLES ONTO A SUBSTRATE, COMPRISING A REACTOR FOR PRODUCING THE PARTICLES TO BE SPRAYED

(71) Applicant: Commissariat a L'Energie Atomique et Aux Energies Alternatives, Paris (FR)

(72) Inventor: David PERALTA, Grenoble (FR)

(73) Assignee: Commissariat a L'Energie Atomique et Aux Energies Alternatives, Paris (FR)

(21) Appl. No.: 15/767,256

(22) PCT Filed: Oct. 11, 2016
(86) PCT No.: PCT/EP2016/074363

§ 371 Date: Apr. 10, 2018

(30) Foreign Application Priority Data
Oct. 14, 2015 (FR) 1559766

(51) Int. Cl. B22F 9/24; H01M 4/04; H01M 10/052; B22F 1/00; B22F 3/105; B01J 19/00

(52) U.S. Cl. CPC B22F 9/24; B22F 2999/00; H01M 4/0471; H01M 10/052; B22F 1/0018; B22F 3/1055; B01J 19/0093; B01J 2219/00783; B01J 2219/00828; B01J 2219/00867; B01J 2219/00889; B01J 2219/00903; B01J 2219/00986; B22F 2003/1056; H01M 4/0414

(57) ABSTRACT

A system for spraying particles onto a substrate, including: at least one reactor including at least one inlet for liquid reagents, a reaction zone, and a zone for collection of the particles produced from the liquid reagents in the reaction zone; a dispensing device allowing the particles to be sprayed onto the substrate; and a mechanism guiding the particles from the collection zone towards the dispensing device.

### TECHNICAL FIELD

This invention relates to a system and to a method for spraying particles onto a substrate, this type of system is also referred to as “particle printing system”.

In a non-limiting manner, the invention has applications in the manufacture of printed tracks, of battery components, or of any other electronic component.

A privileged application relates to the additive manufacturing of an object, also referred to as 3D printing, by stacking of successive layers of particles.

### PRIOR ART

In a manner known per se, printing systems deposit or spray onto a substrate an ink comprising particles/pigments in suspension in a solvent. After the deposition of particles onto the substrate, the ink is then dried and the particles are agglomerated/sintered onto the substrate. The formulation of the ink is often very complex, as the latter is usually comprised of different elements. In order to obtain an ink, different steps are necessary.

First of all, the production of particles in the desired materials is carried out. These particles can be obtained by wet synthesis, or dry synthesis. In any case, the installations that allow for the production of these particles are voluminous and impose substantial storage and conditioning of the powders obtained as such.

Among the constituent steps for ink, the formulation of this ink must also be noted, which depends on different parameters such as:
the properties of the material forming the particles: according to these properties, the use of polymers or of various solvents is required depending on the density, the specific surface and the surface condition of the material;
the nature of the printing system: the viscosity of the ink must be precise and specific in order to allow for the correct operation in the printing system;
the function of the deposited layer: this function can condition the adding of additives such as carbon components in order to increase the conductivity of the layer, or the adding of a binder in order to obtain better mechanical strength of the printed material.

Among the other constituent step of the ink, the production of this ink must also be mentioned, often carried out in substantial volumes. This production consequently requires a large quantity of solvents, as well as voluminous installations.

Finally, a final step resides in the conditioning of the ink, usually in cartridges. However, the good suspension of the particles in a cartridge is provided only for a defined duration. Beyond that, the particles risk settling in the cartridge.

Once all of these steps have been carried out, the cartridges are loaded into the printing system and the spraying of the particles contained in the ink can be initiated.

In light of the above, there is a need for simplifying all of this process aiming to spray the particles onto a substrate.

In prior art, it is also known in the field of additive manufacturing, the production of an object by stacking successive layers of powder, with this technique being referred to as 3D printing. The particles to be deposited form the powder, which is first loaded into a dedicated loading area of the machine used. During the handling of the powder carried out in the framework of this loading, the risk of powder dissemination is high. Such a risk also exists during the final step of unloading of the manufactured object, surrounded by the non-bonded powder. This powder dissemination has several disadvantages.

First of all, the particles of powder emitted into the atmosphere generate a loss of material, of which the financial impact can be substantial. Then, this loss can lead to an undesired variation in the composition. This is for example the case when the powder handled is comprised of a mixture of powders of different natures, as the stoichiometry can then be altered.

The dissemination of powder can also require increased maintenance of the equipment. Indeed, these powders deposited in the working environment are vectors of fouling for machinery. Consequently, specific maintenances action can be generated by an uncontrolled dissemination.

The dissemination of powder can also generate risks for the health and safety of the operators. For example, inhalation or contact of the skin with a powder considered to be dangerous can have effects on health, by causing irritations, allergies, damage to the nervous system, and even cancers. Even powders considered to be inert, i.e. without any specific toxicity, can, when they are present, in a substantial quantity, cause a lung overload and possibly associated with a pulmonary fibrosis.

In order to allow for a secure handling with regards to the problems of dissemination or the powdery nature of the powder, several solutions have already been proposed in prior art, such as the implementation of installations for capturing dust. However, these solutions can be improved and are not necessarily suited to the field of additive manufacturing of objects by stacking successive layers of powder.

### SUMMARY OF THE INVENTION

In order to at least partially respond to the disadvantages concerning the realisations of prior art, the invention first of all has for object a system for spraying particles onto a substrate, according to the characteristics of claim 1.

The invention cleverly provides to couple, in the same system, a reactor for the production of particles and a dispensing device of these particles onto the substrate.

By directly synthesising the particles in situ in the system for spraying, the preliminary steps aiming for the production of these particles are largely simplified. In particular, the particles are no longer stored in the form of ink in cartridges. Consequently, due to the suppression of the step of production of the ink, the quantities of solvents involved are advantageously reduced. It is no longer required to obtain a stabilised ink which prevents the sedimentation of the particles in the cartridges. The implementing of stabilising elements, such as polymers or others, is therefore no longer required. A strong ecological impact advantageously stems from this.

The invention procures other advantages, described hereinbelow.

First of all, as indicated hereinabove, the particles to be sprayed are produced directly in the system, preferably continuously and as requested, in a controlled manner. It is consequently no longer necessary to synthesise these particles in large quantities in voluminous reactors. In this respect, it is noted that many applications require the use of metal nanoparticles or nanoparticles of oxides. However synthesising these particles in large quantities, as well as the storage and handling of them, are extremely difficult on a large scale. Implementing the miniaturised reactor in the system for spraying makes it possible to directly obtain metal nanoparticles or nanoparticles of oxides, by becoming free from all of the aforementioned problems.

Also, the invention makes it possible to print highly reactive compounds using particles that are difficult to store, such as for example metal nanoparticles, certain catalysts, etc. For example, nanometric particles of aluminium are highly pyrophoric, and it is extremely difficult to synthesise them, store them and handle them. The in situ synthesis proposed by the invention therefore makes it possible to be free from these problems.

Finally, it is noted that the invention also makes it possible to avoid the risks of dissemination of the particles, as the latter are not directly handled by the operator. Indeed, only the liquid reagents are loaded into the system for spraying, with these same reagents leading to the synthesis of the particles in the system, thanks to the integrated reactor, provided for this purpose.

The invention preferably has at least one of the following additional characteristics, taken separately or in a combination.

Said reactor is a microfluidic reactor, preferably of the type comprising plates made of silica, silicon, glass, ceramic or plastic having etched channels, or of the type comprising capillary tubes communicating with each other.

The dispensing device also comprises a mixing member arranged in the zone for mixing, said mixing member being preferably an ultrasound probe, or an acoustic mixing system.

The portion downstream from the mixing zone forms a buffer zone, with this buffer zone indeed making it possible to form a reservoir in order to store a quality of mixture required to allow for the spraying of the mixture on demand. In other terms, this reservoir makes it possible to confer a certain inertia to the system in such a way as to avoid a situation where there is a lack of ink. Of course, this buffer zone can also be provided when the synthesised particles are sprayed without having been mixed beforehand with additive elements.

Preferably, the system comprises several reactors, in order to produce particles of different natures.

The system is configured for the production of at least one battery component, preferably a lithium battery, although other applications can be considered, without leaving the scope of the invention. For example, this could be fuel cell components, preferably with ion exchange membranes, or printing tracks on a printed circuit.

According to an application considered, the system is an additive manufacturing machine configured for the carrying out via 3D printing of at least two adjacent battery components, preferably a collector and an electrode formed on the collector.

Preferably, the system also comprises means for sintering particles. Alternatively, these means for sintering could be provided in a module separated from the system for spraying, without leaving the scope of the invention.

Finally, the system for spraying particles is configured in such a way that the particles coming from the reactor have a shape of which the largest dimension is less than 100 μm. More generally, the particles coming from the reactor are particles preferably of nanometric size, have a large dimension between 1 nm and 100 μm, preferably between 1 nm and 1 μm.

The invention also has for object a method for spraying particles onto a substrate using a system such as described hereinabove, with the method comprising the following steps:
supplying the reactor with liquid reagents;
controlling the chemical reaction in the reactor;
controlling the flow rate of particles sprayed onto the substrate by the dispensing device.

According to a possibility offered by the invention, the substrate can be rolled out.

According to a privileged application of the invention, the latter finally has for object a method for manufacturing via 3D printing of at least two adjacent battery components, preferably a collector and an electrode formed on the collector, with the method being implemented using a system such as described hereinabove and comprising two reactors respectively configured to supply first particles as well as second particles, with one of said two adjacent battery components being carried out using the first particles which are first deposited then sintered, in order to then be used as a substrate for the deposition of the second particles forming, after sintering, the other of said two adjacent battery components.

Other advantages and characteristics of the invention shall appear in the non-limiting detailed description hereinbelow.

### BRIEF DESCRIPTION OF THE DRAWINGS

This description will be given with regards to the annexed drawings among which:

FIG. 1 diagrammatically shows a system for spraying particles according to a preferred embodiment of the invention;

FIG. 2 diagrammatically shows a portion of the microfluidic reactor provided on the system shown in the preceding figure;

FIGS. 3a to 3c show different operating configurations of the microfluidic reactor;

FIG. 4 is a perspective view of a battery of which at least some of the components can be produced using the system for spraying particles shown in the preceding figures; and

FIG. 5 is a view diagramming a step in the manufacturing of one of the components of the battery shown in the preceding figure.

### DETAILED DESCRIPTION OF PREFERRED EMBODIMENTS

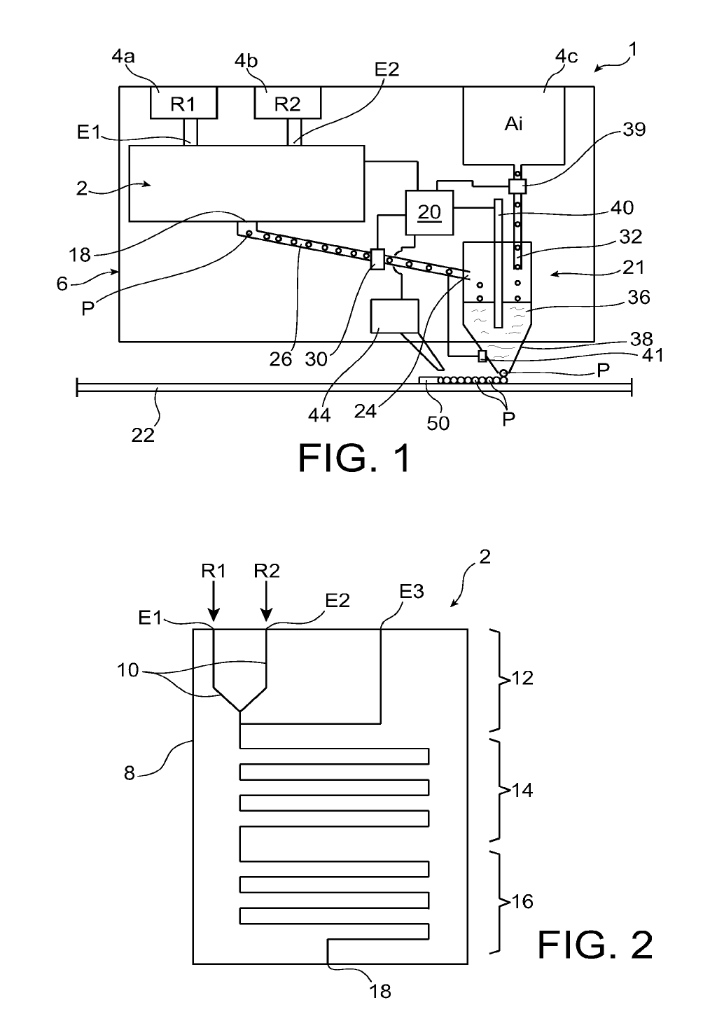

In reference first of all to FIG. 1, a system 1 for spraying particles P is shown according to a preferred embodiment of the invention. This system 1 is also referred to as particle deposition system or particle printing system, and has the particularity of integrating a microfluidic reactor 2 for the production of these particles P.

Indeed, the reactor 2 comprises inlets E1, E2 for the intake of liquid reagents R1, R2, with these inlets being connected to reservoirs of reagents 4a, 4b provided in the system 1 itself. These reservoirs 4a, 4b can as such be accessed from the outside of the system 1, by being protected by an exterior cover 6 of this system.

FIG. 2 shows an embodiment of the microfluidic reactor 2, formed using one or several plates 8 made from silica, silicon, glass, ceramic, polymer or plastic, having etched channels 10 for the circulation of the liquid reagents R1, R2. In addition to the inlets E1, E2, the reactors optionally comprise an inlet E3 for the intake of oil.

In the downstream direction, this reactor 2 comprises a zone for intake and mixing 12, a reaction zone 14, a heating zone 16, as well as a zone 18 for the collection of the particles P. The heating zone 16 makes it possible to heat the generated particles at high temperature, in order to favour the oxidation thereof. Alternatively, the heating zone can be offset off of the substrate in a stainless-steel coil brought to temperature.

This type of reactor 2 has the advantage of allowing for total control on the morphology of the synthesised particles P, thanks to the control unit 20 of the system 1. Indeed, the control unit 20 makes it possible to control the residence time of the mixture in the reaction zone 14, and as such have perfect control of the germination of the particles P. Their growth can then be controlled by managing the residence time and the temperature in the heating zone 16. Generally, the particles P desired at the outlet of the reactor 2 are particles of nanometric size, i.e. their largest dimension is between 1 nm and 1 μm.

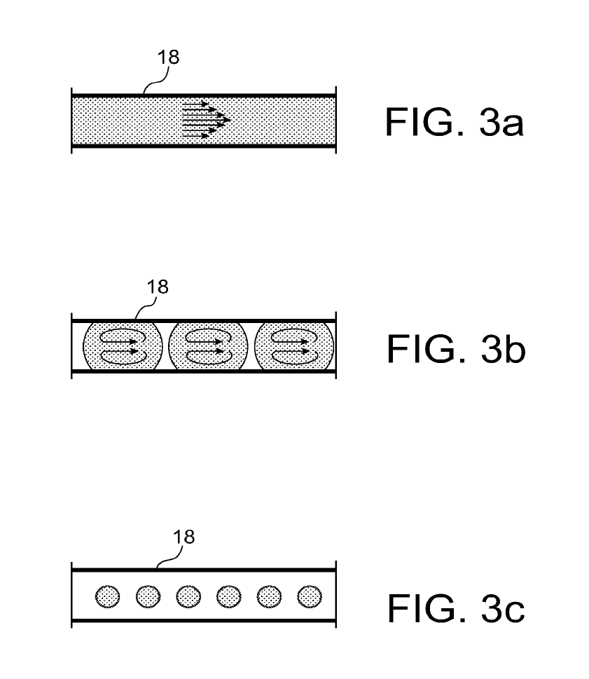

Controlling the reactor 2 can result in different operating modes, shown in FIGS. 3a to 3c. The first operating mode shown in FIG. 3a corresponds to a continuous flow rate mode in the zone 18 for the collection of the particles. In the operating mode in FIG. 3b, corresponding to a segmented mode, the reaction mixture is segmented into several units using an immiscible fluid. Finally, in the droplet mode of FIG. 3c, the reaction mixture is segmented into several units that do not touch the walls of the zone 18 in the form of a conduit.

In the case of use in continuous mode, there is the risk that the flow of the reaction mixture is not uniform, and therefore the particles do not all have the same residence time in the reactor. From this stems a risk that synthesised particles have different properties. As such, the two other fragmented injection modes are preferred, either by using two immiscible fluids, or by using a gas/liquid mixture.

According to the diversity of the particles P to be sprayed onto the substrate, the system 1 can be provided with several separate reactors, of, the type of the one described hereinabove. In this case, each one of the reactors 2 is designed to deliver particles of different natures, according to the liquid reagents used.

Returning to FIG. 1, the system 1 comprises a dispensing device 21 that makes it possible to spray the particles P onto a substrate 22. This device 21 comprises a collector of particles 24, connected to the collection zone 18 of the reactor by a conduit for guiding particles 26. This conduit 26 is provided with a control valve 30 to adjust the flow rate of particles P penetrating into the collector 24 of the dispensing device 21. The valve 30 is controlled by the unit 20 built into the system for spraying 1.

In this preferred embodiment, a mixture of the synthesised particles P with one or several additive elements Ai is desired, for example a polymer binder of the PVDF type, a carbon or metal compound, in order to favour conductivity. To do this, the dispensing device 21 is also provided with a collector 32 of additive elements Ai, this collector 32 being connected to a reservoir of additive elements 4c, integrated into the system 1. The flow rate of additive elements Ai introduced into the mixing zone 36 is controlled by a valve 39 controlled by the unit 20.

The particles P and the additive elements Ai are in a mixing zone 36 of the dispensing device 21, with this mixing zone 36 leading to a nozzle 38 for spraying the mixture of particles and additive elements onto the substrate 22.

In order to favour the mixing in the zone 36, the dispensing device 21 is also provided with a mixing member 40 arranged in this zone 36. The member 40 takes for example the form of an ultrasound probe, controlled by the unit 20.

The downstream portion of the mixing zone 36 forms a buffer zone, i.e. a reservoir for storing a quantity of mixture required in order to allow for the spraying of the mixture on demand by the nozzle 38. A valve 41 controlled by the unit 20 makes it possible to adjust the flow rate desired through the nozzle 38.

In this respect, it is noted that the projection of the particles P by the nozzle 38 is carried out in such a way as to implement a known printing technique, such as inkjet, screen-printing, aerosol jet printing.

Finally, the system for spraying 1 can also comprise conventional means for sintering 44, making it possible to consolidate the particles P after the deposition thereof onto the substrate 22. However, these means 44 could be offset from the system 1, without leaving the scope of the invention. In the case where they are built into the system 1, they are preferably controlled by the control unit 20.

According to a first application example of the invention, the system for spraying 1 is dedicated to the production of a battery component, preferably an electrode for lithium battery.

To do this, particles P are sprayed onto a scrolling sheet of aluminium, forming the substrate 22. The particles P deposited by the system 1 are then sintered in order to ensure the consolidation thereof. By way of example, the particles P are of the nanoparticles of oxides type, and are obtained using reagents. In this respect, it is noted that the precursors of nanoparticles are of the dissolved metal salt type, precipitators of the carbonate type, etc., and other elements known to those skilled in the art.

The method implemented for the continuous obtaining of the electrode 50 onto the substrate 22, comprises the supply of the reactor 2 by the operator, with liquid reagents R1, R2. Then, the other steps are controlled by the control unit 20. They include controlling the chemical reaction in the reactor 2, controlling the flow rate of particles P introduced into the dispensing device 21, controlling any flow rate of additive elements Ai introduced into the device 21, controlling the mixing probe 40, as well as controlling the flow rate of particles P sprayed onto the substrate 22 by the nozzle 38.

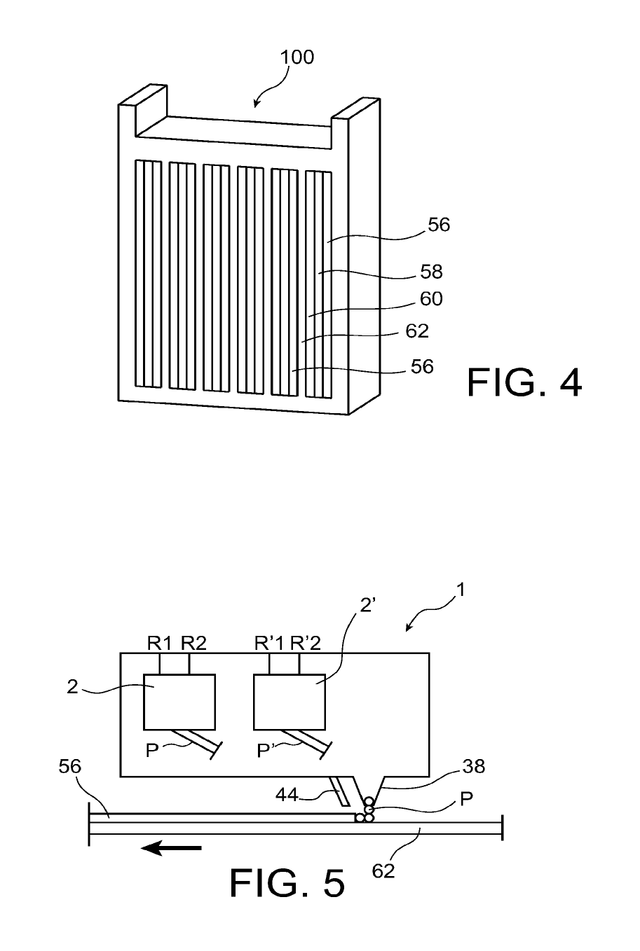

FIG. 4 shows a lithium battery 100 of known design, comprising the stacking of the following elements: a cathode 56, an electrolyte 58, an anode 60, a current collector 62, a cathode 56, etc.

The first example of application described hereinabove can as such allow for the production of the cathode 56 by spraying of particles onto a collector 62 in the form of a sheet of aluminium, and/or the production of the anode 60 by spraying of particles onto this collector 62.

A second example of application still relates to the batteries, but for the successive production of at least two adjacent components by 3D printing. Preferably, this is the production via 3D printing of the collector 62 and of the cathode 56 superimposed on the collector. To do this, the system 1 takes the form of an additive manufacturing machine that allows for the implementing of a method shown in FIG. 5. The machine 1 is then identical or similar to the system described hereinabove, with the particularity of having two microfluidic reactors 2, 2′, each one intended to be supplied with liquid reagents R1, R2; R′1, R′2. The two reactors are connected to the same dispensing device 21, or to separate devices built into the machine 1.

First of all, the current collector 62 is formed by spraying of particles P′ coming from the reactor 2′, these particles being of the metal nanoparticle type, preferably nanoparticles of aluminium. These particles P′, referred to as first particles, are obtained using the following reagents R′1, R′2: aluminium salt, copper salt. They are sprayed onto a substrate (not shown), which can be another component of the battery 100.

After spraying, these first particles P′ are sintered by the dedicated means 44. The step of manufacturing of the collector 62 can be carried out in several successive layers, stacked according to the direction of stacking of the elements comprising the battery 100. Each layer of particles P′ is first deposited, then sintered. The, the collector 62 formed as such can be used as a substrate for the deposition of the cathode 56. The latter is indeed carried out by spraying of particles P coming from the reactor 2, with these particles being of the nanoparticles of oxides type, preferably nanoparticles of metal oxides. These particles P, referred to as second particles, are obtained using the following reagents R1, R2: Nickel salt, Manganese salt, cobalt salt, lithium salt as well as a solution that allows for the precipitation of the metallic solution such as NaOH, KOH, LiOH, Na2CO3, etc.

After spraying, these second particles P are sintered by the dedicated means 44. This step of manufacturing of the cathode 56 can be carried out in several successive layers, stacked according to the direction of stacking of the elements comprising the battery 100. Here too, each layer of particles P is first deposited, then sintered.

This series of steps is carried out as many times as necessary for integrating the battery components desired in the final part, produced by 3D printing. This part could for example integrate an electrolyte, an anode, etc.

Finally, it is noted that in this method of manufacturing, each one of the components of the battery 100 can itself by carried out using several types of particles, without leaving the scope of the invention.

Of course, various modifications can be made by those skilled in the art to the invention that has just been described, solely as non-limiting examples.

1-11. (canceled)

12. A system for spraying particles onto a substrate, comprising:
at least one reactor comprising at least one inlet for liquid reagents, a reaction zone, and a zone for collection of the particles produced from the liquid reagents in the reaction zone;
a dispensing device allowing the particles to be sprayed onto the substrate;
means for guiding the particles from the collection zone towards the dispensing device;
a collector of the particles;
a collector of additive elements;
a zone for mixing the particles and the additive elements;
a nozzle for spraying a mixture of the particles and the additive elements.

13. A system according to claim 12, wherein the reactor is a microfluidic reactor, comprising plates made from silica, silicon, glass, ceramic, polymer or plastic having etched channels, or comprising capillary tubes communicating with each other.

14. A system according to claim 12, wherein the dispensing device further comprises a mixing member or ultrasound probe arranged in the zone for mixing.

15. A system as claimed in claim 12, wherein a portion downstream from the zone for mixing forms a buffer zone.

16. A system as claimed in claim 12, comprising plural reactors.

17. A system as claimed in claim 12, configured to carry out at least one battery component.

18. A system as claimed in claim 12, as a machine of additive manufacturing configured to carry out via 3D printing of at least two adjacent battery components, or a collector and an electrode formed on the collector.

19. A system as claimed in claim 12, further comprising means for sintering particles.

20. A system as claimed in claim 12, configured such that the particles coming from the reactor have a shape of which a largest dimension is less than 100 μm.

21. A method for spraying particles onto a substrate using a system as claimed in claim 12, comprising:
supplying the reactor with liquid reagents;
controlling chemical reaction in the reactor;
controlling a flow rate of particles sprayed onto the substrate by the dispensing device.

22. A method of manufacturing via 3D printing of at least two adjacent components of a battery, or a collector and an electrode formed on the collector, implemented using a system according to claim 12 and comprising:
two reactors respectively configured to supply first particles and second particles, with one of the two adjacent battery components being carried out using the first particles which are first deposited then sintered, to then be used as a substrate for deposition of the second particles forming, after sintering, the other of the two adjacent battery components.
